(19) United States
(12) Patent Application Publication
(10) Pub. No.: US 2005/0030000 A1
(43) Pub. Date: Feb. 10, 2005

(54) Reference voltage generator circuit

(75) Inventor: Hajime Hayashimoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC Electronics Corporation

(21) Appl. No.: 10/911,660

(22) Filed: Aug. 5, 2004

(30) Foreign Application Priority Data
Aug. 8, 2003 (JP) 2003-290209

(51) Int. Cl. G05F 3/16

(52) U.S. Cl. 323/313

(57) ABSTRACT

A reference voltage generator circuit for generating a reference voltage and outputting the voltage from an output terminal comprises a constant current source circuit having a current mirror circuit, for outputting a reference voltage; and first and second current-voltage converter circuits connected in parallel to an output of the constant current source circuit, wherein the second current-voltage generator circuit outputs a reference voltage lower than a bandgap voltage.

### BACKGROUND OF INVENTION

1. Field of Invention

The present invention relates to reference voltage generator circuits and, particularly, to a reference voltage generator circuit with less power voltage dependency and temperature dependency.

2. Description of Related Art

A bandgap reference voltage generator circuit is known as a reference voltage generator circuit with less power voltage dependency and temperature dependency. In the bandgap reference voltage generator circuit, an output reference voltage is fixed to about 1.25V, which is a bandgap voltage. Recently, low-voltage semiconductor devices have been developed. Conventional bandgap reference voltage generator circuits are incapable of generating a reference voltage of less than 1.25V.

Japanese Unexamined Patent Application Publication No. 11-045125 proposes a low-level reference voltage generator circuit. It introduces an improved structure of the bandgap reference voltage generator circuit. FIG. 8 shows a basic structure of the reference voltage generator circuit according to this conventional art, and FIG. 9 shows a circuit diagram. In this circuit, an output current from a first current source circuit 11 and an output current from a second current source circuit 12 are added together in a current adder circuit 13. A current-voltage converter circuit 14 converts the sum of the currents into a voltage, thereby creating a reference voltage Vref.

As shown in FIG. 9, the first power source circuit 11 includes a first current path and a second current path between a power voltage VDD and a ground potential Vss, and a first differential amplifier 11. The first current path has a PMOS transistor P11 and a diode D11. The source of the PMOS transistor P11 is connected to the power voltage VDD and the drain is connected to the anode of the diode D11. The cathode of the diode D11 is connected to the ground potential. The second current path has a PMOS transistor P12, a resistor R11, and a diode D12. The source of the PMOS transistor P12 is connected to the power voltage VDD and the drain is connected to one end of the resistor R11. The other end of the resistor R11 is connected to the anode of the diode D12. The cathode of the diode D12 is connected to the ground potential. The inverting input terminal of the first differential amplifier Amp11 is connected to the drain of the PMOS transistor P11, and the non-inverting input terminal of the first differential amplifier Amp11 is connected to the drain of the PMOS transistor P12. Output from the first differential amplifier Amp11 is supplied to the gates of the PMOS transistors P11 and P12.

The second current source circuit 12 includes a third current path and a second differential amplifier Amp12. The third current path has a PMOS transistor P15 and a resistor R12. The source of the PMOS transistor P15 is connected to the power voltage VDD and the drain is connected to one end of the resistor R12. The other end of the resistor R12 is connected to the ground potential. The inverting input terminal of the second differential amplifier Amp12 is connected to the drain of the PMOS transistor P11, and the non-inverting input terminal of the second differential amplifier Amp12 is connected to the drain of the PMOS transistor P15. Output from the second differential amplifier Amp12 is supplied to the gate of the PMOS transistor P15.

The current adder circuit 13 has a PMOS transistor P13 and a PMOS transistor P14. The source of the PMOS transistor P13 is connected to the power voltage VDD, the gate is connected to the output of the first differential amplifier Amp11, and the drain is connected to a reference voltage output terminal 15. The source of the PMOS transistor P14 is connected to the power voltage VDD, the gate is connected to the output of the second differential amplifier Amp12, and the drain is connected to the reference voltage output terminal 15. The current-voltage converter circuit 14 has a resistor R13. One end of the resistor R13 is connected to the reference voltage output terminal 15 and the other end is connected to the ground potential Vss.

The PMOS transistors P11, P12, and P13 constitute a current mirror circuit. The current I₀₁ flowing through each of these PMOS transistors is thus equal. Further, the PMOS transistors P14 and P15 constitute a current mirror circuit. The current I₀₂ flowing through each of these transistors is thus equal.

The current flowing through the resistor R13 of the current-voltage converter circuit 14 is equal to the sum of the currents I₀₁ and I₀₂. The current I₀₁ is the current through the PMOS transistor P13 and I₀₂ is the current through the PMOS transistor P14.

The reference current I₀₁ of the first current source is given by:
I₀₁=(R11)⁻¹(kT/q)1 nM (1)

The reference current I₀₂ of the second current source is given by:
I₀₂=Vf(R12)⁻¹ (2)
where the PMOS transistors P11, P12, P13, P14, and P15 have the same size (W/L ratio) and designed to have the same operating characteristics, the diode D12 is composed of the M-number of diodes D11 connected in parallel, and a forward voltage of the diode D11 is Vf.

The output reference voltage Vref is given by:
Vref=R13(I₀₁+I₀₂) (3)

Substitution of Eq.(1) and (2) into Eq.(3) yields:
Vref=(R13/R12){(R12/R11)(kT/q)1 nM+Vf} (4)

Since Eq. (4) has no term of power voltage VDD, there is no power voltage dependency. Further, since (kT/q) has positive temperature dependency and Vf has negative temperature dependency, the temperature dependency can be eliminated by appropriately setting the ratio of resistances. The circuit shown in FIG. 9 generates a low level of reference voltage based on Eq.(4).

The circuit shown in FIG. 9 has two differential amplifiers and two power source circuits. The number of elements is thereby large to undesirably increase a circuit area and current consumption.

### SUMMARY OF THE INVENTION

The present invention has been accomplished to solve the above problems. To this end, according to one aspect of the present invention, there is provided a reference voltage generator circuit for generating a reference voltage and outputting the voltage from an output terminal comprising a constant current source circuit having a current mirror circuit for outputting a reference voltage and first and second current-voltage converter circuits connected in parallel to an output of the constant current source circuit, wherein the second current-voltage generator circuit outputs a reference voltage lower than a bandgap voltage.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a block diagram showing the structure of a reference voltage generator circuit according to the present invention;

FIG. 2 is a circuit diagram showing a reference voltage generator circuit according to a first embodiment of the invention;

FIG. 3 is a graph showing a simulation result of the first embodiment;

FIG. 4 is a circuit diagram of a reference voltage generator circuit according to a second embodiment of the invention;

FIG. 5 is a graph showing a simulation result of the second embodiment;

FIG. 6 is a circuit diagram of a reference voltage generator circuit according to a third embodiment of the invention;

FIG. 7 is a graph showing a simulation result of the third embodiment;

FIG. 8 is a block diagram showing the structure of a reference voltage generator circuit according to a conventional art; and

FIG. 9 is a circuit diagram showing a reference voltage generator circuit according to the conventional art.

### DESCRIPTION OF THE PREFERRED EMBODIMENTS

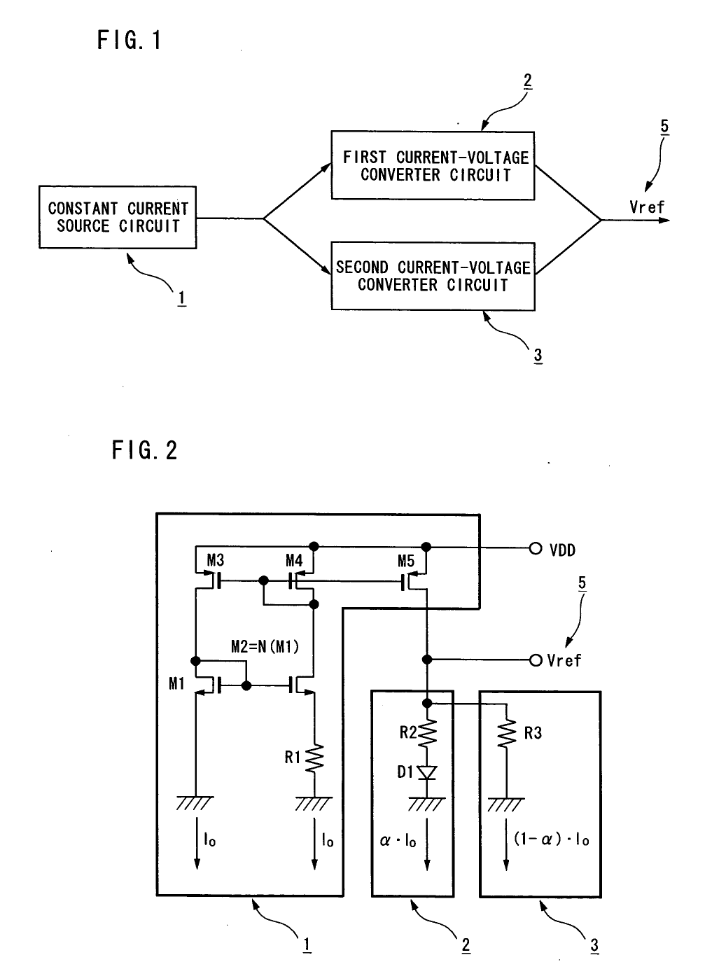

FIG. 1 is a block diagram showing a reference voltage generator circuit according to the present invention. The reference voltage generator circuit of the present invention has a constant current source circuit 1, a first current-voltage converter circuit 2, and a second current-voltage converter circuit 3. A reference voltage generator circuit can generate a voltage lower than a bandgap voltage if it has first and second current-voltage converter circuits.

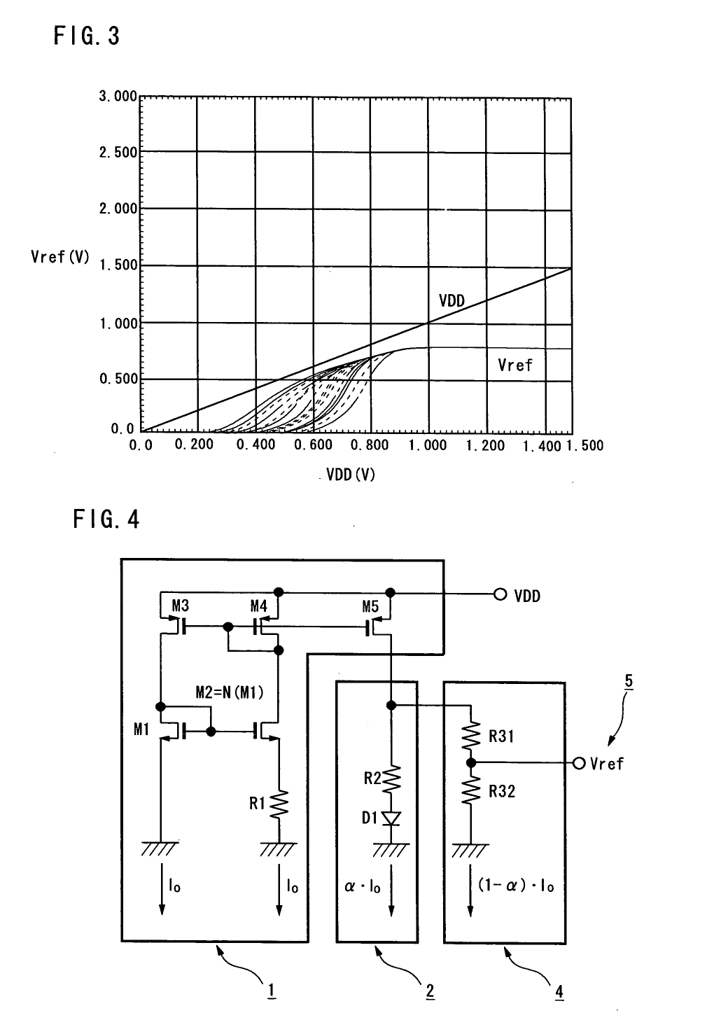

FIG. 2 is a circuit diagram showing a reference voltage generator circuit according to a first embodiment of the invention. FIG. 3 is a graph showing a Simulation Program with Integrated Circuit Emphasis (SPICE) simulation result of the circuit of FIG. 2. The first embodiment will be explained hereinafter with reference to FIG. 2.

The reference voltage generator circuit of the first embodiment has the constant current source circuit 1, the first current-voltage converter circuit 2, and the second current-voltage converter circuit 3. The constant current source circuit 1 is composed of current mirror circuits. The first and second current-voltage converter circuits 2 and 3 divide the current outputted from the constant current source circuit 1 and convert each of the divided currents into a voltage.

The constant current source circuit 1 has NMOS transistors M1, M2, and PMOS transistors M3, M4, M5, and a resistor R1. The sources of the PMOS transistors M3, M4, M5 are each connected to a power voltage VDD, and the gates of those are each connected to the drain of the PMOS transistors M4. The drain and gate of the NMOS transistor M1 are connected to the drain of the PMOS transistor M3, and the source is connected to a ground potential. The drain of the NMOS transistor M2 is connected to the drain of the PMOS transistor M4, the gate is connected to the gate of the NMOS transistor M1, and the source is connected to one end of the resistor R1. The other end of the resistor R1 is connected to the ground potential Vss. Each pair of the PMOS transistors M3 and M4, M4 and M5, and the NMOS transistors M1 and M2 constitutes a current mirror circuit. A current I_{∘} flowing through each of the transistors is thereby equal.

The first current-voltage converter circuit 2 has a resistor R2 and a diode D1. One end of the resistor R2 is connected to the drain of the PMOS transistor M5, and the other end is connected to the anode of the diode D1. The cathode of the diode D1 is connected to the ground potential. A current αI_{∘} flows through the first current-voltage converter circuit 2. The current αI_{∘} is a current divided from a constant current I_{∘}. The constant current I_{∘} is a current flowing through the PMOS transistor M5 of the constant current generator circuit 1.

The second current-voltage converter circuit 3 has a resistor R3. One end of the resistor R3 is connected to the drain of the PMOS transistor M5 and the other end is connected to the ground potential Vss. A current (1−α) I_{∘} flows through the second current-voltage converter circuit 2. The current (1−α) I_{∘} is the rest of the current divided from the constant current I_{∘}. A connection node between the drain of the PMOS transistor M5 of the constant current source current 1, and the first and second current-voltage converter circuits 2 and 3 is an output terminal 5 of a reference voltage Vref. The reference voltage Vref is outputted from the output terminal 5.

The PMOS transistors M3, M4, and M5 have the same characteristics and the same size (W/L ratio: L is a gate channel length and W is a gate width). The NMOS transistor M2 is composed of the N-number of NMOS transistors M1 connected in parallel. The NMOS transistor M2 thus operates in a subthreshold region.

If a constant current through each transistor is I_{∘}, a current through the first current-voltage converter circuit 2 is αI_{∘}, a current through the second current-voltage converter circuit 3 is (1−α) I_{∘}, and a forward direction voltage of the diode D1 is VF, the constant current I_{∘} is given by:
I_{∘}=(R1)⁻¹(kT/q)1 nN (5)
The reference voltage Vref is given by:

$$\begin{matrix}Vref = α {I}_{o} R2 + VF & ( 6 ) \\ = ( 1 - α ) {I}_{o} R3 & ( 7 )\end{matrix}$$

Rearrangement of Eq.(6) and (7) gives:
α=[I_{∘}R3−VF]/[I_{∘}(R2+R3)] (8)
Substitution of Eq.(8) into Eq.(6) yields:
Vref=R3(R2+R3)⁻¹{(R2/R1)(kT/q)1 nN+VF} (9)
Differentiation of Eq. (9) with respect to temperature T yields:
ΔVref/ΔT=R3(R2+R3)⁻¹{(R2/R1)(kT/q)1 nN+ΔVF/ΔT} (10)

Since Eq. (9) indicating a reference voltage has no term of power voltage VDD, it has no power voltage dependency. Further, a given low level of reference voltage can be obtained by appropriately setting a resistance value. In Eq.(10), the temperature characteristics of VF have negative temperature dependency, which is about −2 mV/° C. Thus, setting an appropriate ratio of the resistors R1 and R2 allows eliminating the temperature dependency.

The first embodiment is now explained with specific numerical values.

Setting values in this embodiment are as follows: The ratio of the resistors are: R1, R2=12R1, R3=1.7R1, The ratio N of the transistors M1 and M2 is: N=11, The forward voltage and temperature characteristics of the diode D1 are:
VF=0.53(V), ΔVF/ΔT=−2.48(mV/° C.), kT/q=26(mV).

Substitution of the above setting values into Eq.(9) and (10) gives:
Vref=0.8V, ΔVref/ΔT=0.

FIG. 3 shows a SPICE simulation result for confirmation of the above. The simulation is conducted under the following conditions:

Threshold variation of each transistor: ±25%

Temperature: −40° C., 25° C., 120° C.

A reference voltage Vref with respect to a power voltage under the above conditions is calculated. As indicated in FIG. 3, the reference voltage Vref=0.8V and ΔVref/ΔT=0 when the power voltage is 0.9V and above.

In the first embodiment, the first and second current-voltage converter circuits 2 and 3 are connected in parallel to the drain of the PMOS transistor M5 of the constant current circuit 1. The constant current circuit 1 has current mirror circuits and outputs a constant current. The outputted constant current is divided into two currents to be inputted into the first and second current-voltage converter circuits 2 and 3. The currents flowing through the first and second current-voltage converter circuits 2 and 3 are each converted into a voltage, thereby obtaining a reference voltage of a lower level than a bandgap voltage.

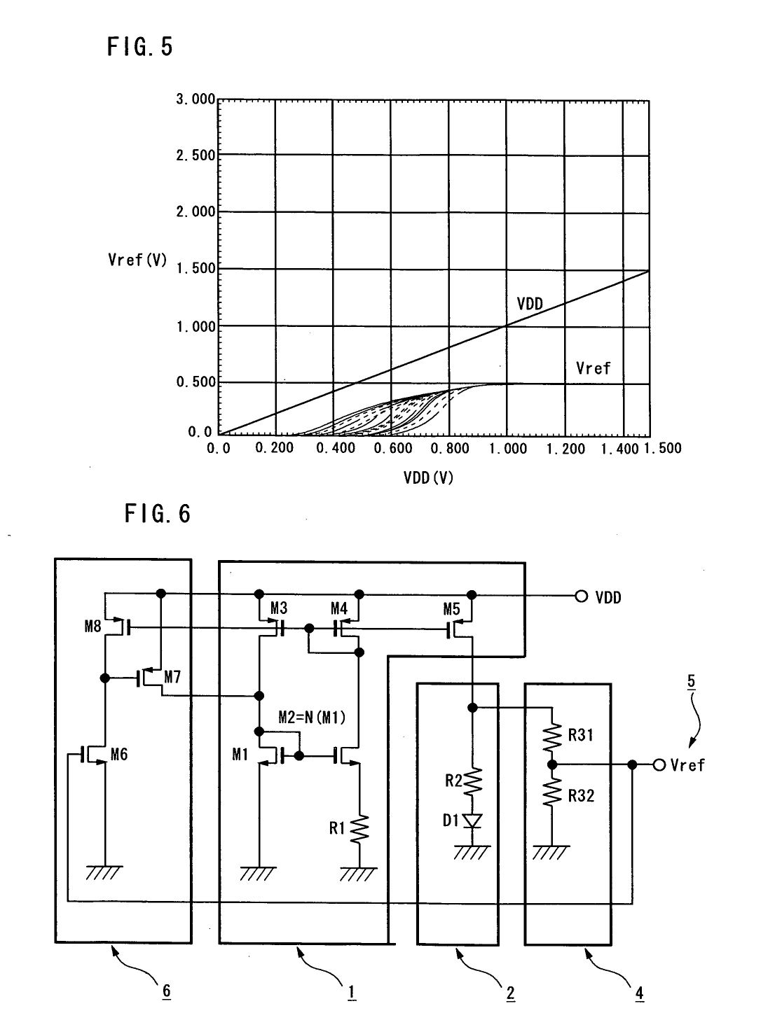

A second embodiment of the present invention is explained hereinafter with reference to FIGS. 4 and 5. FIG. 4 shows a circuit diagram of the second embodiment, and FIG. 5 shows a SPICE simulation result of the circuit. The second embodiment allows obtaining a reference voltage that is still lower than the voltage obtained in the first embodiment. The circuit of the second embodiment shown in FIG. 4 is different from the circuit of the first embodiment in the second current-voltage converter circuit. In the second embodiment, the resistor R3 of the second current-voltage converter circuit shown in FIG. 2 is divided into two resistors. Thus, the second current-voltage converter circuit 4 has resistors R31 and R32 connected in series. The output terminal 5 of the reference voltage Vref is a connection node between the resistors R31 and R32. The other elements in FIG. 4 are the same as those in FIG. 2. The same elements are denoted by the same reference symbols and redundant description is omitted.

Following from Eq.(9), a reference voltage Vref obtained in the circuit structure shown in FIG. 4 is given by:
Vref=R32(R2+R31+R32)⁻¹{(R2/R1)(kT/q)1 nN+VF} (10)
Substitution of R32=(5/3)R31 into Eq.(10) yields: Vref=0.5V

FIG. 5 shows a SPICE simulation result of the second embodiment for confirmation. The conditions of the simulation are the same as those in the first embodiment. As indicated in FIG. 5, the reference voltage is Vref=0.5V and ΔVref/ΔT=0 when the power voltage is 0.9V and above. The value of Vref=0.5V is lower than the reference voltage Vref in the first embodiment.

The second embodiment divides the resistor of the second current-voltage converter circuit. By setting the connection between the divided resistors as the reference voltage output terminal, it is possible to obtain a still lower reference voltage than the reference voltage obtained in the first embodiment.

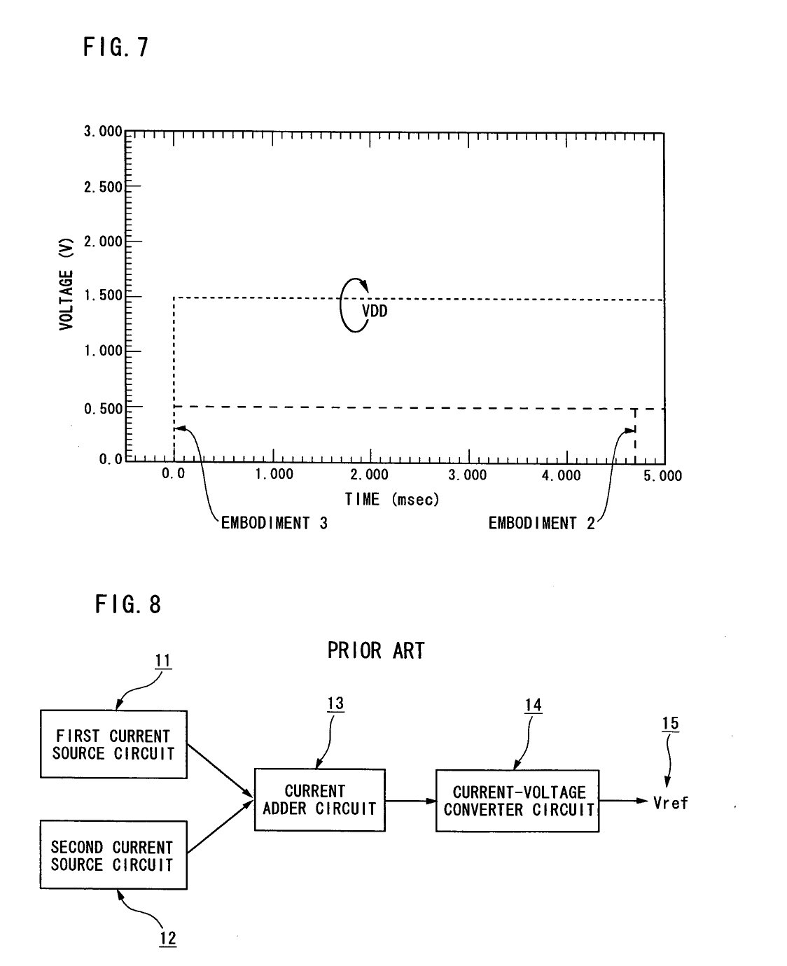

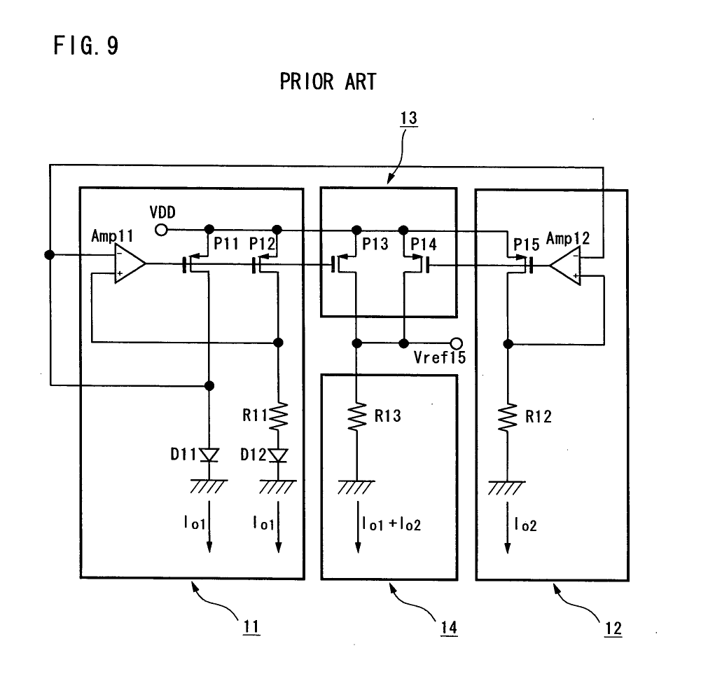

FIG. 6 is a circuit diagram showing a third embodiment of the invention. FIG. 7 is a graph showing the time to generate a reference voltage. The first and second embodiments require several msec to generate a reference voltage after power-on. The third embodiment allows reducing the elapsed time to generate a reference voltage.

The circuit of the third embodiment has a startup circuit 6 in addition to the circuit shown in FIG. 4. The other elements in FIG. 6 are the same as those in FIG. 4, and the same elements are denoted by the same reference symbols and redundant description is omitted.

The startup circuit 6 has a NMOS transistor M6 and PMOS transistors M7 and M8. The gate of the NMOS transistor M6 receives a reference voltage as a control signal, and the source is connected to a ground potential Vss. The source of the PMOS transistor M7 is connected to a power voltage VDD, the gate is connected to the drain of the NMOS transistor M6, and the drain is connected to the drain of the NMOS transistor M1 in the constant current source circuit 1. The source of the PMOS transistor M8 is connected to the power voltage VDD, the gate is connected to the gate of the PMOS transistor M4 in the constant current source circuit 1, and the drain is connected to the drain of the NMOS transistor M6.

Normally, in reference voltage generator circuits, a constant current starts flowing after power is turned on. Hence, reference voltage generator circuits have a transistor with low current supply capacity. The transistors M1 to M5 shown in FIG. 6 also have low current supply capacity. Thus, it takes several msec to generate a reference voltage after power is on. The current supply capacity of each transistor of the startup circuit 6 in the third embodiment is set as follows. The PMOS transistor M7 has high current supply capacity for high-speed operation. The PMOS transistor M8 has low current supply capacity. The NMOS transistor M6 has very low current supply capacity. The size of each transistor is determined according to target current supply capacity.

The operation of the startup circuit 6 is explained below. At the time of power-on, all connection nodes of circuit elements are at ground potential. As the power voltage increases, the connection nodes are charged by the transistors M3, M4, M5, M7, and M8, of which sources are connected to the power voltage. Since the transistors M3, M4, and M5 in the constant current source circuit 1 have low current supply capacity, the charge speed is low. On the other hand, the gate of the PMOS transistor M7 in the startup circuit 6 is connected to the ground potential via junction capacitance and overlap capacitance of the NMOS transistor M6. Since the PMOS transistor M7 has high current supply capacity, the charge speed is high. As a result, the PMOS transistor M7 drastically raises the gate voltage of the transistors M1 and M2 in the constant current source circuit 1. In this way, the startup circuit 6 allows each connection node to quickly reach an operating voltage. This allows the reference voltage generator circuit to quickly enter stable operation.

When a reference voltage is generated, it is supplied to the gate of the NMOS transistor M6. The reference voltage is smaller than a bandgap voltage. The NMOS transistor M6 is set to have very low current supply capacity, and the voltage supplied to its gate is also small. Thus, very low current flows through the NMOS transistor M6. The drain voltage of the NMOS transistor M6 thereby increases to turn off the PMOS transistor M7. With the PMOS transistor M7 turned off, the startup circuit 6 ceases to affect the constant current source circuit 1. Further, since the gate of the NMOS transistor M6 receives a reference voltage that is lower than a bandgap voltage, it is not necessary to greatly reduce the W/L of the transistor, which allows reducing the layout area. Furthermore, since the current flowing through the NMOS transistor M6 is very small, current consumption of the startup circuit 6 is negligible. By adding the startup circuit with a small layout area and low power consumption, it is possible to obtain a reference voltage generator circuit with a short risetime after power-on. FIG. 7 shows the time to generate a reference voltage. The second embodiment with no startup circuit takes several msec to generate a reference voltage. The third embodiment with the startup circuit 6, on the other hand, immediately generates a reference voltage.

Though the third embodiment explains the case where the startup circuit is added to the second embodiment, the startup circuit may be added to the first embodiment.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

1. A reference voltage generator circuit for generating a reference voltage and outputting the voltage from an output terminal, comprising:
a constant current source circuit having a current mirror circuit, for outputting a reference voltage; and
first and second current-voltage converter circuits connected in parallel to an output of the constant current source circuit,
wherein the second current-voltage generator circuit outputs a reference voltage lower than a bandgap voltage.

2. The reference voltage generator circuit according to claim 1, wherein the first current-voltage converter circuit comprises a first resistor and a forward diode connected in series between the output of the constant current source circuit and a ground potential, the second current-voltage converter circuit comprises a second resistor connected between the output of the constant current source circuit and the ground potential, and the output terminal is a connection between the constant current source circuit and the first and second current-voltage converter circuits.

3. The reference voltage generator circuit according to claim 1, wherein the first current-voltage converter circuit comprises a first resistor and a forward diode connected in series between the output of the constant current source circuit and a ground potential, the second current-voltage converter circuit comprises a second resistor and a third resistor connected in series between the output of the constant current source circuit and the ground potential, and the output terminal is a connection between the second resistor and the third resistor.

4. The reference voltage generation circuit according to claim 1, wherein the constant current source circuit comprises:
a first current mirror circuit comprising a first transistor of which drain and gate are connected to each other and source is connected to a ground potential, and a second transistor of which gate is connected to the gate of the first transistor and source is connected to a ground potential via a resistor;
a second current mirror circuit comprising a third transistor of which drain and gate are connected to each other and source is connected to a power voltage, and a fourth transistor of which source is connected to the power voltage and gate is connected to the gate of the third transistor; and
a third current mirror circuit comprising a fifth transistor of which source is connected to the power voltage and gate is connected to the gate of the third transistor,
the drain of the first transistor and the drain of the third transistor are connected, the drain of the second transistor and the drain of the fourth transistor are connected, and the drain of the fifth transistor outputs the reference current.

5. The reference voltage generator circuit according to claim 2, wherein the constant current source circuit comprises:
a first current mirror circuit comprising a first transistor of which drain and gate are connected to each other and source is connected to the ground potential, and a second transistor of which gate is connected to the gate of the first transistor and source is connected to the ground potential via a third resistor;
a second current mirror circuit comprising a third transistor of which drain and gate are connected to each other and source is connected to a power voltage, and a fourth transistor of which source is connected to the power voltage and gate is connected to the gate of the third transistor; and
a third current mirror circuit comprising a fifth transistor of which source is connected to the power voltage and gate is connected to the gate of the third transistor,
the drain of the first transistor and the drain of the third transistor are connected, the drain of the second transistor and the drain of the fourth transistor are connected, and the drain of the fifth transistor outputs the reference current.

6. The reference voltage generator circuit according to claim 3, wherein the constant current source circuit comprises:
a first current mirror circuit comprising a first transistor of which drain and gate are connected to each other and source is connected to the ground potential, and a second transistor of which gate is connected to the gate of the first transistor and source is connected to the ground potential via a fourth resistor;
a second current mirror circuit comprising a third transistor of which drain and gate are connected to each other and source is connected to a power voltage, and a fourth transistor of which source is connected to the power voltage and gate is connected to the gate of the third transistor; and
a third current mirror circuit comprising a fifth transistor of which source is connected to the power voltage and gate is connected to the gate of the third transistor,
the drain of the first transistor and the drain of the third transistor are connected, the drain of the second transistor and the drain of the fourth transistor are connected, and the drain of the fifth transistor outputs the reference current.

7. The reference voltage generator circuit according to claim 1, further comprising a startup circuit for activating the reference voltage generator circuit at power-on, wherein a control signal of the startup circuit is the reference voltage.

8. The reference voltage generator circuit according to claim 2, further comprising a startup circuit for activating the reference voltage generator circuit at power-on, wherein a control signal of the startup circuit is the reference voltage.

9. The reference voltage generator circuit according to claim 3, further comprising a startup circuit for activating the reference voltage generator circuit at power-on, wherein a control signal of the startup circuit is the reference voltage.

10. The reference voltage generator circuit according to claim 4, further comprising a startup circuit for activating the reference voltage generator circuit at power-on, wherein a control signal of the startup circuit is the reference voltage.

11. The reference voltage generator circuit according to claim 10, wherein the startup circuit comprises:
a sixth transistor of which gate receives the reference voltage as a control signal and source is connected to the ground potential;
a seventh transistor of which gate is connected to the drain of the sixth transistor, drain is connected to the drain of the first transistor, and source is connected to the power voltage; and
an eighth transistor of which gate is connected to the gate of the fourth transistor, drain is connected to the drain of the sixth transistor, and source is connected to the power voltage.

12. The reference voltage generator circuit according to claim 5, further comprising a startup circuit for activating the reference voltage generator circuit at power-on, wherein a control signal of the startup circuit is the reference voltage.

13. The reference voltage generator circuit according to claim 12, wherein the startup circuit comprises:
a sixth transistor of which gate receives the reference voltage as a control signal and source is connected to the ground potential;
a seventh transistor of which gate is connected to the drain of the sixth transistor, drain is connected to the drain of the first transistor, and source is connected to the power voltage; and
an eighth transistor of which gate is connected to the gate of the fourth transistor, drain is connected to the drain of the sixth transistor, and source is connected tot the power voltage.

14. The reference voltage generator circuit according to claim 6, further comprising a startup circuit for activating the reference voltage generator circuit at power-on, wherein a control signal of the startup circuit is the reference voltage.

15. The reference voltage generator circuit according to claim 14, wherein the startup circuit comprises:
a sixth transistor of which gate receives the reference voltage as a control signal and source is connected to the ground potential;
a seventh transistor of which gate is connected to the drain of the sixth transistor, drain is connected to the drain of the first transistor, and source is connected to the power voltage; and
an eighth transistor of which gate is connected to the gate of the fourth transistor, drain is connected to the drain of the sixth transistor, and source is connected tot the power voltage.
